(19) United States
(12) Patent Application Publication
(10) Pub. No.: US 2008/0273436 A1
(43) Pub. Date: Nov. 6, 2008

(54) Integrated Photo Monitor Circuit and Optical Pickup Unit

(75) Inventor: Marinus Adrianus Henricus Looijkens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,594

(22) PCT Filed: Jan. 21, 2005
(86) PCT No.: PCT/IB05/50255

§ 371 Date: Aug. 1, 2006

(30) Foreign Application Priority Data
Feb. 5, 2004 (EP) 04100431.8

(51) Int. Cl. G11B 7/125; G11B 7/00

(52) U.S. Cl. 369/53.26; 369/47.5

(57) ABSTRACT

The invention provides an integrated photo monitor circuit (12), particularly an integrated photo monitor circuit (12) for CD and DVD applications, comprising a photo detector (14), an amplifier (16) for amplifying an output signal of said photo detector (14), and sampling circuitry (18) for sampling an output signal of said amplifier (16). The invention further provides an optical pickup unit (10), particularly an optical pickup unit (10) for CD and DVD applications, comprising means (20, 22) for emitting light, and means (12) for generating a sampled feedback signal (40) correlated to the output power of said means (20, 22) for emitting light and intended to be evaluated for controlling said output power of said means (20, 22) for emitting light. By providing the sampling function on the optical pickup unit (10), especially in an integrated photo monitoring circuit (12), the necessary bandwidth of a flex connection (32) between the optical pickup unit (10) and a printed circuit board (42) may be reduced compared to solutions where the sampling is done on the printed circuit board (42).

### FIELD OF THE INVENTION

The present invention relates to integrated photo monitor circuits for monitoring the output power of light sources like laser diodes. The invention also relates to optical pickup units, for example used in DVD/CD recording and playback devices.

### BACKGROUND OF THE INVENTION

For example known CD/DVD read and write devices comprise an optical pickup unit for reading and writing data on optical data carriers. The optical pickup unit comprises at least one light emitting device like a laser diode for emitting light onto the optical data carrier and means for receiving light reflected from the optical carrier. It is well known to control the output power of the laser diode to achieve proper reading and writing results.

For controlling the output power of the laser diode it is necessary to determine the actual output power of the laser diode. Therefore, known optical pickup units comprise a photo detector, usually a photo diode, detecting light directly emitted from the laser diode and/or reflected from the optical data carrier. The output signal of the photo detector is amplified, usually by a current to voltage amplifier, and then sampled and evaluated for controlling the output power of the laser diode. With known solutions the output signal of the photo detector is amplified on the optical pickup unit and the sampling and further evaluating is done on a printed circuit board connected to the optical pickup unit via a flex connection. The printed circuit board comprises circuitry creating a laser power control signal depending on the actual laser power, wherein the laser power control signal in turn is transported back to the optical pickup unit via the flex connection.

The advantage of using an integrated photo monitor circuit, for example realized in BiCMOS technology, instead of a discrete photo diode in combination with a discrete current to voltage amplifier to provide laser power feedback information is well known in the art. Integrated photo monitor circuits where the photo detector and the current to voltage amplifier are integrated have a substantially higher bandwidth compared to solutions comprising a discrete photo diode and a discrete current to voltage amplifier.

To perform a proper sampling, it is additionally necessary in many cases to further supply timing information to the sampling circuitry. Such timing information may for example be delivered by means located on the optical pickup unit for creating the write strategy. In this case also the timing information has to be supplied to the printed circuit board via the flex connection.

With the prior art there is a problem in that it is expensive to provide a flex connection between the optical pickup unit and the printed circuit board comprising the necessary bandwidth for transporting the high frequency laser feedback and timing information, respectively.

It is therefore the object of the present invention to further develop the known integrated photo monitor circuits and the known optical pickup units such that the necessary bandwidth of the flex connection between the optical pickup unit and the printed circuit board is reduced.

### SUMMARY OF THE INVENTION

The above object is solved by the features of the independent claims. Further developments and preferred embodiments of the invention are outlined in the dependent claims.

In accordance with a first aspect of the present invention, there is provided an integrated photo monitor circuit, particularly an integrated photo monitor circuit for CD and DVD applications, comprising a photo detector, an amplifier for amplifying an output signal of said photo detector, and sampling circuitry for sampling an output signal of said amplifier. Such an integrated photo monitor circuit is able to deliver a laser power feedback signal requiring only a relatively small bandwidth for transmission. Therefore, if the integrated photo monitor circuit in accordance with the invention is located on an optical pickup unit it is no longer necessary to transport the analog forward laser power feedback signal and the timing information, respectively, over the flex connection between the optical pickup unit and the printed circuit board. Instead, only a sampled analog output signal representing the actual laser output power has to be transported over the flex connection. This reduces the necessary bandwidth of the flex connection.

The integrated photo monitor circuit in accordance with the present invention preferably further comprises an input for receiving timing information used for sampling. Such timing information may for example be created by a laser driver which is also intended to create the write strategy.

Furthermore, it is preferred to fabricate the integrated photo monitor circuit in accordance with the present invention in CMOS or BiCMOS technology. Especially the BiCMOS technology has an excellent price-performance ratio.

It is also preferred that said amplifier of the integrated photo monitor circuit is a current to voltage amplifier. The resulting voltage signal can directly be used for sampling, in many cases.

In this context it is furthermore advantageous if the integrated photo monitor circuit in accordance with the present invention is adapted to be mounted to an optical pickup unit. For example, the integrated photo monitor circuit may comprise contacts suitable for any type of known soldering processes.

In accordance with a second aspect of the present invention, there is provided an optical pickup unit, particularly an optical pickup unit for CD and DVD applications, comprising means for emitting light, and means for generating a sampled feedback signal correlated to the output power of said means for emitting light and intended to be evaluated for controlling said output power of said light emitting device. Thereby, it is also no longer necessary to transport the analog forward laser power feedback signal and the timing information over the flex connection between the optical pickup unit and the printed circuit board. Even in this case, only a sampled analog output signal representing the actual laser output power has to be transported over the flex connection, and the necessary bandwidth of the flex connection is reduced.

In preferred embodiments of the present invention, the optical pickup unit further comprises an interface for connecting said optical pickup unit via a flex connection to a printed circuit board comprising a controller for controlling said output power of said means for emitting light. The interface preferably enables a high frequency data transport between the printed circuit board and the optical pickup unit and allows the controller located on the printed circuit board to supply a laser output power control signal back to the optical pickup unit.

It may also be advantageous if the optical pickup unit comprises a controller for controlling said output power of said means for emitting light. In this case the bandwidth needed for communication between the optical pickup unit and the printed circuit board is further reduced since, for providing the laser output power control signal no bandwidth of the flex connection is required.

Furthermore, it is preferred in accordance with the present invention that said means for generating said sampled feedback signal further comprise a photo detector detecting light emitted by said means for emitting light. This photo detector may for example be realized by at least one photo diode and, if necessary, by further circuitry.

Depending on the respective embodiment of the optical pickup unit in accordance with the present invention, said means for generating a sampled feedback signal further comprise a current to voltage amplifier for amplifying an output signal of said photo detector, and sampling circuitry for sampling an output signal of said current to voltage amplifier.

Without being limited thereto, it is preferred for all embodiments of the invention that said means for generating said sampled feedback signals are realized by an integrated photo monitor circuit, particularly by an integrated BiCMOS photo monitor circuit. The use of such an integrated photo monitor circuit enables a reduction of the space required on the optical pickup unit for providing the means for generating the sampled feedback signals, a reduction of the overall weight of the optical pickup unit, and provides a high bandwidth. Employing the BiCMOS technology for fabricating the means for generating sampled feedback signals ensures fast information processing, low power consumption, and an excellent price-performance ratio.

It is particularly advantageous if said means for generating said sampled feedback signal receive timing information generated on said optical pickup unit by means for creating a write strategy for writing to an optical data carrier, wherein said timing information is used for sampling. With the write strategy generator on the optical pickup unit, the timing information needed to sample the forward sense signal, i.e. the signal proportional to the actual laser power, is easily generated.

Furthermore, it is preferred that said means for emitting light comprise a laser diode. By the application of a laser diode excellent beam qualities, high output power and high data rates can be achieved.

All devices for reading and/or writing optical storage media comprising an integrated photo monitor circuit in accordance with the present invention and/or an optical pickup unit in accordance with the present invention fall within the scope of the accompanying claims.

It is the gist of the present invention to reduce the high frequency bandwidth needed for the communication between an optical pickup unit and a printed circuit board by performing the sampling of a forward laser output power feedback signal on the optical pickup unit instead of on the printed circuit board. This is very efficiently possible by providing an integrated photo monitor circuit in accordance with the invention on an optical pickup unit in accordance with the invention. Although the invention may advantageously be used in the field of reading/writing optical data carriers, especially the integrated photo monitor circuit in accordance with the invention may also be used in other technical fields where high optical data rates have to be processed, for example in optical communication components or range finding applications.

These and other aspects of the invention will be apparent from and elucidated with reference to the embodiments described hereinafter.

### BRIEF DESCRIPTION OF THE DRAWINGS

FIG. 1 shows a simplified block diagram of an optical pickup unit in accordance with an embodiment of the present invention comprising an integrated photo monitor circuit in accordance with an embodiment of the present invention, as well as a printed circuit board connected to the optical pickup unit by a flex connection.

### DESCRIPTION OF PREFERRED EMBODIMENTS

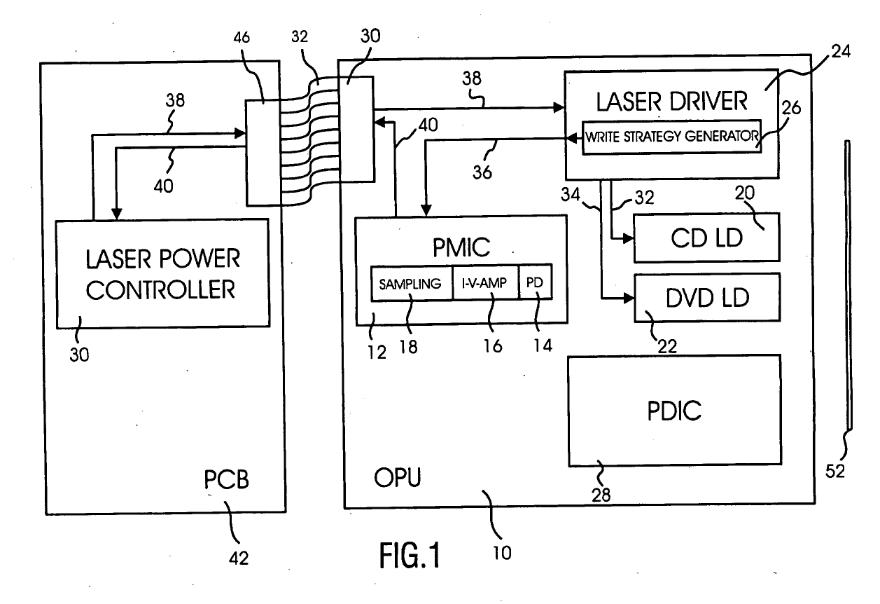

It is to be noted that FIG. 1 only shows elements necessary for understanding the present invention, and that practical embodiments of optical pickup units may comprise additional elements not shown in FIG. 1. Furthermore, in practical embodiments the blocks shown in FIG. 1 may be further divided or combined in any suitably manner. The arrows shown in FIG. 1 represent signals which, in practical embodiments, may be supplied by one or more lines, as appropriate.

In FIG. 1 there is shown an optical pickup unit (OPU) 10 connected to a printed circuit board (BCP) 42 via a flex connection 32. The optical pick up unit 10 is intended to write data to and read data from an optical data carrier 52 which, in the embodiment shown, may be a CD or DVD. The optical pick up unit 10 comprises a laser driver 24 for driving a first laser diode (CD LD) 20 adapted to operate at CD wavelengths and a second laser diode (DVD LD) 22 adapted to operate at DVD wavelengths. Furthermore, the optical pickup unit 10 comprises an integrated photo detector circuit (PDIC) 28 which for the purpose of reading data from the optical data carrier 52 is adapted to receive light emitted by the laser diodes 20 and 22 and reflected by the optical data carrier 52. However, the integrated photo detector circuit 28 is not relevant for understanding the present invention. On the optical pick up unit 10 there is further provided an integrated photo monitor circuit (PMIC) 12 comprising a photo detector portion 14, a current to voltage amplifier portion 16 and a sampling portion 18. The optical pick up unit 10 also comprises an interface 30 adapted to couple the optical pick up unit 10 to the printed circuit board 42 via the flex connection 32. A similar interface 46 is provided for the same purpose on a printed circuit board 42, which additionally comprises a laser power controller 30. In practical embodiments the printed circuit board 42 comprises a complete chip set (not shown) for performing various data processing functions necessary in CD and DVD applications.

In operation, one of the laser diodes 20, 22 emits light with an output power which is controlled by a closed loop. For providing this closed loop, light directly emitted by one of the laser diodes 20, 22 and/or light reflected from the optical data carrier 52 is received by the photo detector portion 14 of the integrated photo monitor circuit 12. The photo detector portion 14 outputs a signal which is amplified by the current to voltage amplifier portion 16 of the integrated photo monitor circuit 12. In accordance with the present invention, the integrated photo monitor circuit 12 comprises a sampling portion 18 for sampling the amplified output signal of the current to voltage amplifier 16. To achieve a proper sampling result, it is necessary to provide timing information to the sampling portion 18. In the present case, this timing information is created by a write strategy generator 26 which is part of the laser driver 24. The timing information is supplied by a timing signal 36 to the integrated photo monitor circuit 12 and the sampling portion 18, respectively. The sampling portion 18 outputs a sampled laser power forward feedback signal 40 which is supplied to the laser power controller 30 via the interface 30, the flex connection 32 and the interface 46. The laser power controller 30 evaluates the sampled laser power forward feedback signal 40 and creates a laser power control signal 38 which is fed to the laser driver 24 via the interface 46, the flex connection 32 and the interface 30. The laser driver 24 drives the laser diode 20 or 22 depending on the laser power control signal 38, and thereby the laser power control loop is closed.

All means mentioned herein may be realized by any suitable analog or discrete components well known to the person skilled in the art. Also the use of any type of signal processor is intended to fall within the scope of the accompanying claims. As regards the integrated photo monitor circuit 12, it is preferred that this integrated circuit is realized, at least in part, in BiCMOS technology, as already mentioned.

Furthermore, equivalents and modifications not described above may also be employed without departing from the scope of the invention, which is defined in the accompanying claims.

1. An integrated photo monitor circuit (12), particularly an integrated photo monitor circuit (12) for CD and DVD applications, comprising:
a photo detector (14),
an amplifier (16) for amplifying an output signal of said photo detector (14), and
sampling circuitry (18) for sampling an output signal of said amplifier (16).

2. The integrated photo monitor circuit (12) according to claim 1, further comprising an input for receiving timing information (36) used for sampling.

3. The integrated photo monitor circuit (12) according to claim 1, wherein said integrated photo monitor circuit (12) is an integrated BiCMOS or CMOS circuit.

4. The integrated photo monitor circuit (12) according to claim 1, wherein said amplifier (16) is a current to voltage amplifier.

5. The integrated photo monitor circuit (12) according to claim 1, which is adapted to be mounted to an optical pickup unit (10).

6. An optical pickup unit (10), particularly an optical pickup unit (10) for CD and DVD applications, comprising:
means (20, 22) for emitting light, and
means (12) for generating a sampled feedback signal (40) correlated to the output power of said means (20, 22) for emitting light and intended to be evaluated for controlling said output power of said means (20, 22) for emitting light.

7. The optical pickup unit (10) according to claim 6, further comprising an interface (30) for connecting said optical pickup unit (10) via a flex connection (32) to a printed circuit board (42) comprising a controller (30) for controlling said output power of said means (20, 22) for emitting light.

8. The optical pickup unit (10) according to claim 6, further comprising a controller for controlling said output power of said means (20, 22) for emitting light.

9. The optical pickup unit (10) according to claim 6, wherein said means (12) for generating said sampled feedback signal (40) further comprise a photo detector (14) detecting light emitted by said means (20, 22) for emitting light.

10. The optical pickup unit (10) according to claim 9, wherein said means (12) for generating a sampled feedback signal (40) further comprise:
a current to voltage amplifier (16) for amplifying an output signal of said photo detector (14); and
sampling circuitry (18) for sampling an output signal of said current to voltage amplifier (16).

11. The optical pickup unit (10) according to claim 9, wherein said means (12) for generating said sampled feedback signal (40) are realized by an integrated photo monitor circuit (12), particularly by an integrated BiCMOS photo monitor circuit (12).

12. The optical pickup unit (10) according to claim 6, wherein said means (12) for generating said sampled feedback signal (40) receive timing information (36) generated on said optical pickup unit (10) by means of creating a write strategy for writing an optical data carrier (52), wherein said timing information (36) is used for sampling.

13. The optical pickup unit (10) according to claim 6, wherein said means (20, 22) for emitting light comprise a laser diode (20, 22).

14. A device for reading and/or writing optical storage media (52), characterized in that it comprises an integrated photo monitor circuit (12) according to claim 1.

15. A device for reading and/or writing optical storage media (52), characterized in that it comprises an optical pickup unit (10) according to claim 6.
